(19) United States
(12) Patent Application Publication
(10) Pub. No.: US 2024/0399791 A1
(43) Pub. Date: Dec. 5, 2024

(54) Gearless Portal Axle Assembly

(71) Applicants: Tate Ray Parham, Silverado, CA (US); Joshua Mark Derby, Yorba Linda, CA (US)

(72) Inventors: Tate Ray Parham, Silverado, CA (US); Joshua Mark Derby, Yorba Linda, CA (US)

(21) Appl. No.: 18/800,133

(22) Filed: Aug. 12, 2024

(51) Int. Cl. B60B 35/00; B60B 35/12; B60B 35/16; B60K 17/04; F16H 7/06; F16H 57/02; F16H 57/035

(52) U.S. Cl. CPC B60B 35/001; B60B 35/122; B60B 35/16; B60K 17/043; F16H 7/06; F16H 57/035; B60B 2900/115; B60B 2900/131; B60B 2900/133; B60B 2900/212; B60B 2900/351; B60B 2900/531; F16H 2057/02052

(57) ABSTRACT

A portal axle assembly is an enclosed drive system that is attached to a vehicle's axle, steering or other linkages, relocating vehicle power from an input axle shaft to a displaced (usually lower) output shaft. The output shaft, in turn, drives an attached unit bearing hub assembly that provides power to the vehicle's wheel. The inventive approach of this gearless, direct-drive, chain-and-sprocket design represents a unique and simplified approach that differs significantly from the multi-gear portal technology that is widely utilized in other portal axle designs. The gearless portal is designed to be compatible with floating axle shafts, or not on both the input and output ports, depending on use-case. Differential sprocket sizing provides for changes to drive ratio based on application. Additionally, the design of the portal housing provides for adaptation for attachment to a wide variety of OEM and aftermarket axle housing, suspension, steering linkage and other attachment methods. The portal axle can be readily made to accept a wide range of output hubs, unit bearing, and other methods of wheel attachment.

### BACKGROUND

Portal axle assemblies are used to lift a vehicle's differential and axle housing, leading to increased overall ride-height, tire-size, and vehicle ground clearance. Additionally, intra-portal drive ratio reduction helps maintain torque performance when employing larger tires without having to re-gear upstream components of the vehicle's drivetrain.

Having first appeared on military and agricultural vehicles in the 20th century, portal axles provide a way to increase vehicle and axle-differential housing and axle-arm ground clearance (Especially on but not limited to solid-axle vehicles). Using portals to lift a vehicle's driveline significantly improves a vehicle's ability to drive over severe terrain without parts of the drivetrain and axles getting stuck or damaged. Conversely, some trains use an inverted portal design to lower the train's center of gravity, relative to the axle's traditional station.

In military, agricultural and offroad-enthusiast markets, higher ground clearance allows portal users to also employ larger-diameter tires without any further vehicle modification which in-turn, results in (1) further increases to vehicle ground clearance due to the increase in tire diameter and (2) improvements to tire approach angle (also due to tire diameter increase) when encountering rocks, ledges, or other such obstacles.

Early portal equipped vehicles first utilized a 2-gear portal system that required a reversed driveshaft rotational input because input and output gears/shafts will cause counter-rotation relative to each other in a direct-drive configuration. On later applications, this problem was solved by employing one and later two idler gears between the input and output drive gears to cancel the counter-rotation inherent to two-gear portals as well as increasing the quantity of gear-tooth engagement in 4-gear configuration. Additionally, an intra-portal gear ratio reduction was introduced by utilizing a differentially larger output gear size vs. the input gear. This feature provides the ability to retain torque performance when utilizing larger tires

Multi-gear, hydraulic, and even electric portal designs have been patented (U.S. Pat. No. 8,844,669; U.S. Pat. Pend. No. 20220332185A1; U.S. Pat. Nos. 8,118,133; 8,484,611; 8,985,264; 9,625,021; 7,185,688; U.S. Pat. No. 20210245599; U.S. Pat. No. 11,072,237 B2; U.S. Pat. No. 10,479,156 B2; EP. Pat. No. 2,581,240 B1; EP. Pat No. 1,510,365 B1; DE. Pat No. 10 2004 003 645 A1), with two, three and four-gear designs commonly used in the offroad enthusiast community. The current invention for which patent protection is being applied for utilizes a simplified gearless design employing an inverted/silent chain and sprockets instead of gears. This gearless direct-drive system represents a major design departure from all other previously patented gear-driven portal axle designs.

The appealing benefits of portal axles has long been recognized by the consumer offroad community, but repurposing legacy portals from other vehicles is cumbersome for offroad enthusiasts as it requires modifying a vehicle's stock axle/steering linkages to accept a repurposed portal's unique attachment profile and then further modification to the portal's housing to be compatible with modern unit-bearing hubs that drive a vehicle's wheel. The current generation of “consumer aftermarket” portal axle offerings often employ a modular portal gearbox that incorporates OEM compatible axle/steering linkage attachment and also provides standard attachment compatibility for typical unit bearing hub assemblies in order to attach a typical wheel to the assembly.

Modern off-road enthusiasts often modify their vehicles' suspensions to increase ride-height and allow for larger tires, further increasing differential clearance. The use of portal axles is increasingly thought of as being a superior way to gain significantly more differential clearance relative to suspension modification alone, when compared with similar amounts of overall vehicle lift. Given that modern portal axle manufacturers provide for standard axle attachment and unit-bearing integration on a vehicle-specific basis, portal axles are increasingly recognized as being the preferred method of gaining vehicle and tire clearance in the consumer offroad aftermarket industry.

### BRIEF SUMMARY OF INVENTION

The Gearless chain- and sprocket direct-drive Portal Axle assembly utilizes a chain and two sprockets to provide dislocated (usually lower) input-output power at the vehicle's wheel. Input power is delivered from an axle shaft to the drive sprocket, which transfers power via chain or belt to the driven output sprocket and then to an integrated unit-bearing, hub, or other wheel-attachment device. The relocated drive output provides the ability to both increase a vehicle's driveline ground-clearance and provide the option to employ larger tires due to increased clearance of a tire's diameter relative to a vehicle's bodywork, thus allowing the potential for even further increases to ground-clearance.

The chain and sprocket approach is a major design departure from common multi-gear portal axle offerings. One prominent feature of this “gearless” approach is superior drive tooth-engagement, due to the benefit of significant chain-wrap around the sprockets, engaging many teeth at once. This may provide additional strength for some heavy-duty applications.

The gearless portal may utilize an inverted, “silent”, or other type of matched chain or belt and sprocket protocol, depending on vehicle and use-case. The function of the gearless design may provide advantages in terms of noise and vibration reduction when compared with spur-gears associated with earlier multi-gear designs.

Due to a comparatively large number of sprocket teeth, the gearless portal provides for a wide range of drive ratio optionality providing compensatory operational value in scenarios such as maintaining torque-performance when utilizing oversized tires.

The bifurcated design of the gearless portal's housing provides for ease of adaptation to a variety of methods for portal-vehicle attachment, both on the input and output side of function. The input (proximal) side of the gearless portal can be made to attach to a vehicle's axle housing, steering linkage, suspension componentry or other location(s), including solid-axle, independent suspension, and other OEM applications, providing adaptability for utilization on both existing and future vehicle offerings and use-cases. Similarly, the output (distal) part of the gearless portal housing can be customized to mate to a variety of present and future OEM and aftermarket wheel-mounting devices, including hubs, unit-bearings and other modalities.

Another aspect of the gearless portal design is the provision for the ability to utilize full-floating axles on both the input and output modalities or not, depending on application requirements. This feature allows the vehicle's weight to be transferred through the portal axle's housing to the associated attachment members rather than through the axle shafts, themselves, depending on application and configuration.

The gearless portal axle's assembly additionally provides for adaptation for use of a variety of brake caliper brackets via integral brake mounting surfaces that are designed to be customizable, based on vehicle and intended use case.

### BRIEF DESCRIPTION OF THE DRAWINGS

FIG. 1 is a perspective-view of an assembled gearless portal showing the proximal housing, distal housing including integrated brake bracket mounting and attached unit-bearing.

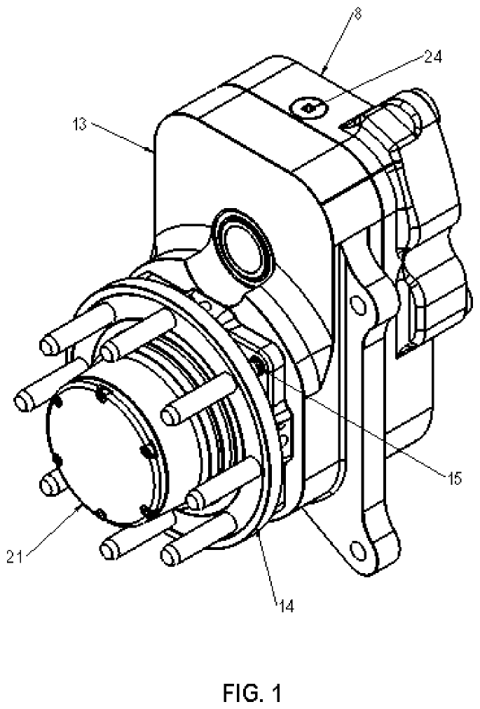

FIG. 2A is a plan view of an assembled gearless portal showing the location of the brake mount on the distal housing, the installed unit bearing, and hub-cap.

FIG. 2B is an elevation view of the assembled gearless portal showing an example of the proximal mounting points to the vehicle and the displaced distal power output to a wheel via a unit-bearing hub.

FIG. 2C is a sectional view showing the internal form of the proximal and distal housing components as well as the installed unit-bearing, and floating output shaft with its hub-cap extension retainer. Locations of oil fill and drain plugs are also shown, along with locations of bearings and seals.

FIG. 2D is a sectional view of how a unit bearing hub mounts to the distal housing. Bolt locations are shown along with locations of bolt-seals.

FIG. 3 is a perspective view of one example of how an assembled gearless portal assembly would attach to a particular vehicle's suspension equipment.

FIG. 4 is an exploded perspective view showing all components, in orientation, for the assembly of a gearless portal axle assembly.

FIGS. 5A and 5B are plan and perspective views, respectively, of an example of a gearless portal axle installed on a vehicle's solid axle housing, showing dislocated power output, an example of mounting bolts for this application and location of oil drain plug on proximal housing face.

FIG. 5C is a sectional view of an example of the gearless portal installed on a solid-axle equipped vehicle's axle housing. Floating input and output shafts can be seen, along with representation of offset between input and output shafts.

### DETAILED DESCRIPTION OF EMBODIMENTS

The Gearless Portal Axle Assembly represents a novel approach to portal axle design that is substantially differentiated from all previously patented multi-gear portal axle iterations in that it utilizes a simplified, gear-free drive mechanism. Designed to be a modular system with the core architecture consisting of two sprockets and a matching laminate chain of any type, the bifurcated proximal and distal housing components are meant to be readily adapted, from a design and manufacture standpoint, for precision fitment to a wide range of current and future vehicle adaptation. Prerequisite to this detailed description of embodiments, the following Table of Components is provided for reference to the included drawings and the following information:

REFERENCE TABLE OF COMPONENTS

| Character Reference# | description |
|---|---|
| 1 | driven sprocket |
| 2 | end cap seal |
| 3 | drive sprocket |
| 4 | end cap |
| 5 | retaining ring |
| 6 | inverted silent chain |
| 7 | bearing inner race |
| 8 | proximal housing |
| 9 | bearing |
| 10 | shaft seal |
| 11 | shear pin |
| 12 | alignment pin |
| 13 | distal housing |
| 14 | wheel unit bearing |
| 15 | wheel bearing bolt |
| 16 | wheel bearing bolt seal |
| 17 | housing attachment bolt |
| 18 | housing seal |
| 19 | output shaft |
| 20 | drive slug |
| 21 | wheel bearing cover |
| 22 | cover screw |
| 23 | drain plug seal |
| 24 | drain plug |
| 25 | vent plug |
| 26 | vent plug adapter |
| 27 | knuckle |
| 28 | portal mount bolt |
| 29 | portal mount threaded stud |
| 30 | Axle housing tube |
| 31 | Axle shaft |

Various embodiments herein provide a mechanism to lift a vehicle from the ends of the axles and/or steering and suspension componentry. In some embodiments the portal mounts to an existing rotating axle steering component 27. In other embodiments the portal mounts to a fixed solid axle component 30. In yet other embodiments, the gearless portal is attached to OEM or aftermarket suspension components such as ball-joints, steering and or suspension linkage components, depending on the vehicle and application.

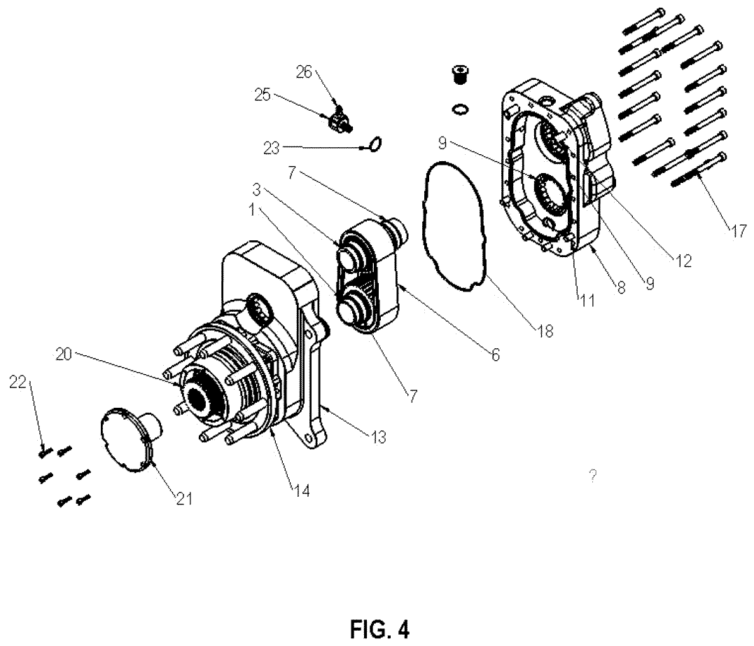

FIG. 4 illustrates how the inventiveness is unique in that a chain and sprocket system is used to transmit torque in contrast to multi-gear portal drive systems.

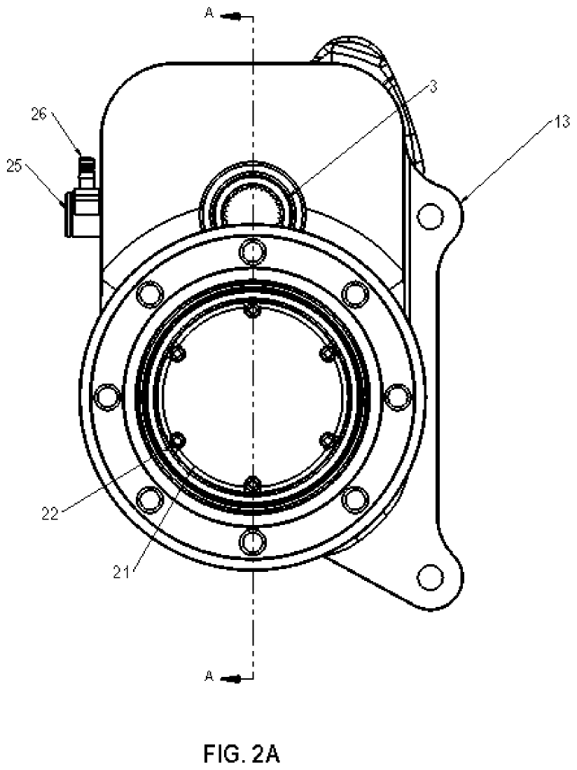

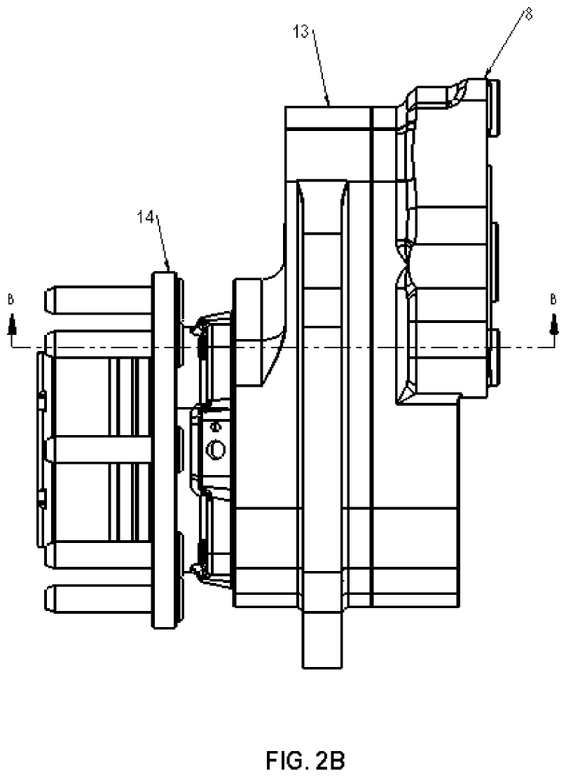

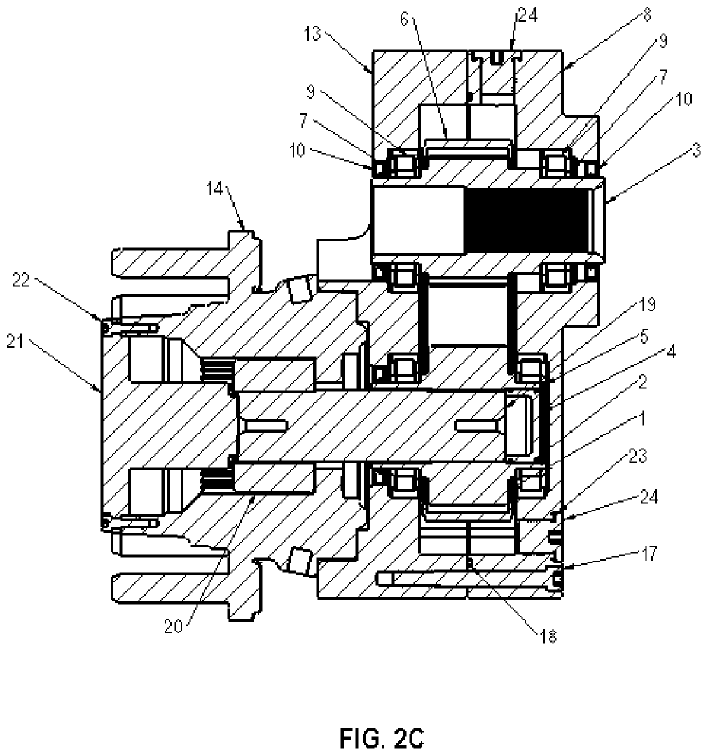

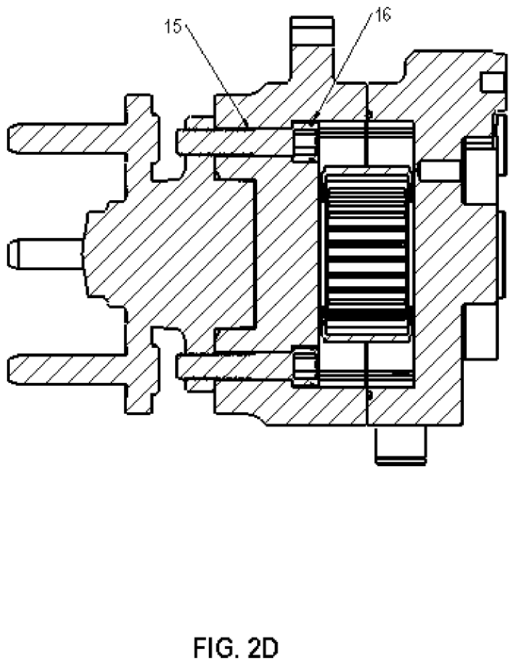

FIG. 2C illustrates a mechanism where there is a drive sprocket 3 with internal splines which mesh with an axle shaft 31. A chain drive system is comprised of an inverted laminate (silent or any other type of laminate chain, so long as sprockets are designed and manufactured to match specified chain profile) chain 6 which wraps around the drive sprocket and extends down to and wraps around a driven sprocket 1.

In the example shown on FIG. 4, both sprockets are supported for radial and thrust loads by a cylindrical bearing set 7, 9, but ball bearings could also be utilized in certain applications generating significant lateral thrust. In some embodiments the inner bearing race 7 can be assembled on to the sprocket. In other embodiments the inner bearing race can be integral to the sprocket giving the sprocket greater strength. Both the drive sprocket 3 and the driven sprocket 1 are supported by a cylindrical bearing set 7, 9 on each side of the sprocket.

The bearings shown on FIG. 4 are held in place both radially and axially by the proximal housing 8 and the distal housing 13. Outside of the bearing is a shaft seal 10 which is held in place and supported by the proximal housing 8. Shaft seals 10 are located at the points where oil could leak out of the chain and sprocket drive chamber. The shaft seals also keep contaminants from getting inside the gearless drive mechanism.

At the proximal side of the sprocket 1 there is an end cap 4. The end cap is held in place with a retaining ring 5. The end cap has a groove that houses a seal 2 to keep the oil from leaking outside of the gearless chain drive chamber.

In the example shown in FIG. 4, the driven sprocket 1 has internal splines that mesh with the proximal end of a floating output shaft 19. In other embodiments and applications, the output shaft can be integral to the driven sprocket. The end cap 4 keeps or supports the axial motion of the output shaft.

in the example shown in FIG. 4, the distal end of the output shaft meshes with a drive slug 20. In other embodiments, the floating or integral output shaft can directly drive a hub, unit bearing or other wheel attachment device without the use of a drive slug. In the example embodiment shown, the drive slug 20 has internal splines that mesh with the output shaft. The drive slug has external splines that mesh with internal splines of a unit bearing 14. The output shaft 19 and the drive slug 14 are supported by the wheel bearing cover 21. This support allows the slug and output shaft to float while transmitting torque. The wheel bearing cover is held in place by cover screws 22.

The proximal housing 8 and the distal housing 13 are fixed together with housing attachment bolts 17. The open area around the chain drive inside the proximal and distal housings is the gearless chain drive chamber. Between the housing surfaces is a seal 18 that keeps oil inside the gearless chain drive chamber while keeping contaminants out.

FIG. 4 shows a perspective exploded view of the portal assembly. The housings 8, 13 are aligned by insertion of alignment pin 12. The housings are fixed by insertion of structural shear pins 11. In FIG. 2C an oil fill cap 24 is located at the top of the proximal housing 8. The oil cap maintains a seal against contaminants getting into the chain drive chamber by compressing seal 23. The oil fill cap 24 and the seal 23 are also the same component as the drain plug 24 and the drain plug seal 23.

FIG. 2A shows an air vent system which is made up of vent plug 25 and vent plug adapter 26 mounted to the side of proximal housing 8. The air vent system attaches to a standard air tube by the vent plug adapter barb feature. A standard tube connected to the vent plug adapter 26 barb can be routed to attach to a standard check-valued filter. This allows for pressure changes inside the sealed chain drive chamber while not allowing contaminants to get inside the chain drive chamber. The vent plug 25 and vent plug adapter 26 can be removed during oil fill to determine oil fill height.

FIG. 2D illustrates how the distal housing 13 attaches to a unit bearing 14. The wheel bearing bolt 15 is assembled from inside the chain drive compartment. In other embodiments, various other unit bearings, hub assemblies or other drive and wheel attachment scenarios can be employed, depending on the vehicle and use case. The bearing bolt seal keeps oil in the chain drive compartment from leaving the chain drive compartment while keeping contaminants out.

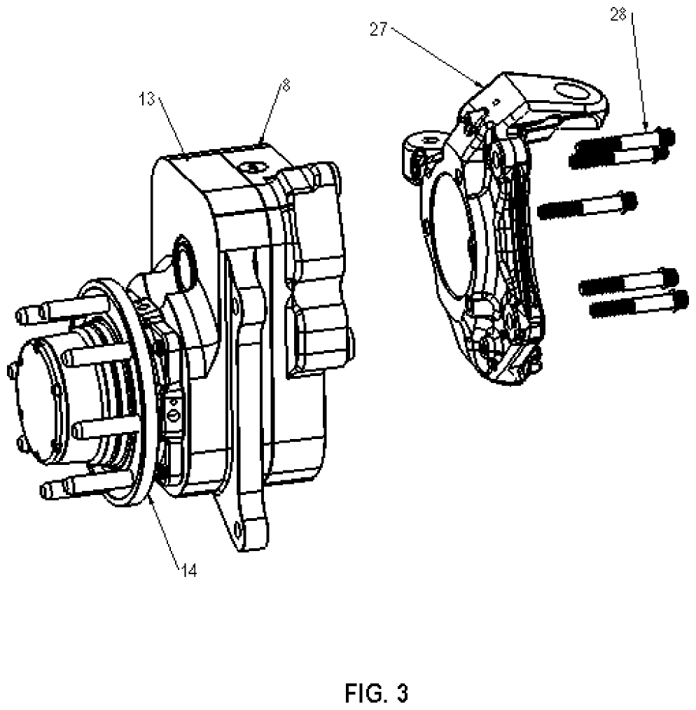

FIG. 3 illustrates how an assembled portal would attach to an existing rotating knuckle 27. The mounting bolts 28 are aligned with the current mounting bolts of the knuckle 27. In other embodiments the proximal housing would be modified for attachment to a variety of vehicle and use case scenarios including axle housing, ball joint, suspension, steering linkage and other componentry depending on the nature of the vehicle and use case. In some embodiments the mount holes for a brake bracket are repurposed for mounting reinforcement of the portal assembly. Customizable brake bracket attachment surfaces may be provided as shown in this embodiment, providing for optionally in brake caliper size and location via customizable, vehicle and application-specific brake caliper adapters.

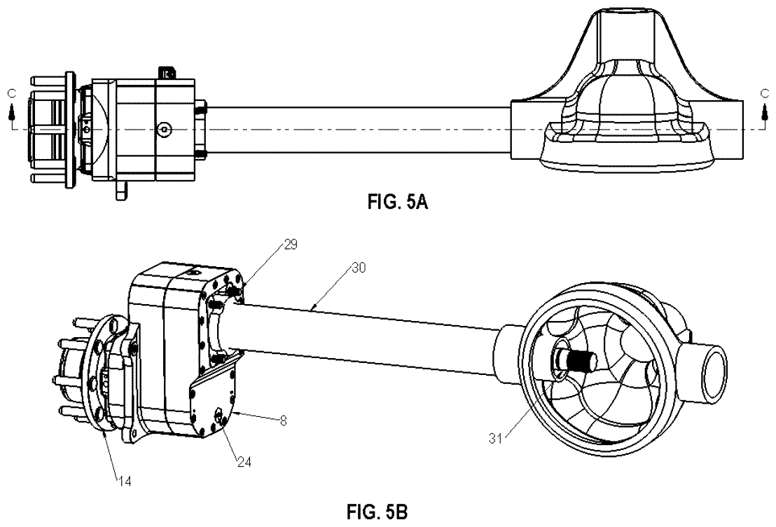

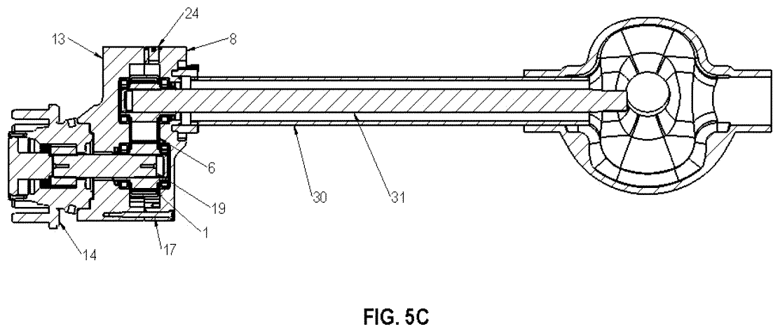

FIGS. 5A & 5B illustrate how a gearless portal assembly attaches to a fixed or solid axle housing assembly. The portal mount stud 29 is fixed to the portal assembly. During assembly the threaded studs line up with holes in the flange of the axle housing tube 30. The portal assembly can be fastened with standard nuts. A pocket in the face of the proximal housing 8 nests around the flange on the axle housing tubing 30. The nest encapsulates the flange creating a resistance to torque created by the axle shaft 31.

1. A Gearless Portal Axle Assembly comprising two sprockets and matching inverted laminate drive chain of any type; a bifurcated housing with the proximal portion attaching to a vehicle's axle and/or suspension componentry of any type; and the distal housing incorporating a vehicle's wheel attachment componentry of any type.

2. The Gearless portal Axle Assembly is a modular drive system whereas portal attachment adaptation to both the proximal and distal bifurcated housings provide for precision fitment to a variety of current and future vehicle input and output scenarios while maintaining the essential integrity of the core gearless drive system.

3. Sprockets and a matching laminate inverted chain as in claim 1 wherein system input power is delivered to the drive sprocket via an axle shaft, transferred via inverted laminate chain of any type to the driven sprocket and output power is delivered via floating or integral output shaft to integrated wheel attachment componentry of any type.

4. Sprockets as in claim 1 wherein differentially sized sprockets can be utilized to modify a vehicle's drive ratio within the gearless portal axle assembly.
